(19) United States
(12) Patent Application Publication
(10) Pub. No.: US 2008/0261533 A1
(43) Pub. Date: Oct. 23, 2008

(54) METHOD AND ARRANGEMENT IN A COMMUNICATIONS NETWORK

(75) Inventors: Henrik Bengtsson, Lund (SE); Troed Sangberg, Malmo (SE)

Correspondence Address: HARRITY SNYDER, L.L.P., 11350 RANDOM HILLS ROAD, SUITE 600, FAIRFAX, VA, 22030, US

(73) Assignee: SONY ERICSSON MOBILE COMMUNICATIONS AB, Lund (SE)

(21) Appl. No.: 11/738,157

(22) Filed: Apr. 20, 2007

(51) Int. Cl. H04B 7/26

(52) U.S. Cl. 455/66.1

(57) ABSTRACT

A method in a first communications device for setting up a point-to-point IP connection to a second communication device is provided. The first device is adapted to communicate with the second device over a radio communication network IP connection. The first device and the second device use a point-to-point radio technology and are adapted to communicate over a point-to-point IP connection. The point-to-point radio technology allows for radio communication within a specific range. The first device is surrounded by a third communication device within the specific range. The third device uses point-to-point radio technology. The method may include: sending a request to the second device over a setup radio communication network IP connection, requesting a point-to-point identity associated with the second device; obtaining from the second device, a point-to-point identity associated with the second device over the radio communication network IP connection; sending a query to the third device, requesting if it is associated with the obtained point-to-point identity obtained from the second device, by using said point-to-point radio technology; receiving a message comprising information that the second device is retrieved and information how to retrieve the second device; and changing the setup IP connection to a point-to-point IP connection.

### TECHNICAL FIELD

The present invention generally relates to a communication devices and connections between communication devices and, more particularly, to changing an established radio communication IP (Internet protocol) connection to a point-to-point IP connection to a second communication device.

### DESCRIPTION OF RELATED ART

Communication between mobile phones in cellular radio communications networks are increasingly used for activities other than just talking, e.g., texting, exchanging image files, music files, text files, etc., from one mobile phone to another over a cellular IP connection. Currently, in the cellular networks, such activities can be very costly due to high fees, tariffs, etc., take an extended time to complete due to the relatively lower bandwidth typically available, and consume processing and power resources in the meantime.

### SUMMARY

Implementations of the invention provide a mechanism in a first communication device for setting up a point-to-point IP connection to a second communication device, thereby enabling faster and more cost-effective data transfer.

In accordance with a first aspect of the present invention, a method in a first communications device (first device) for setting up a point-to-point IP connection to a second communication device (second device), is provided. The first device is adapted to communicate with the second device over a radio communication network Internet protocol (IP) connection. The radio communication network may include a radio communication network using radio base stations. The first device and the second device may use a point-to-point radio technology and be adapted to communicate over a point-to-point IP connection. The point-to-point radio technology may allow for radio communication within a specific range. The first device may be surrounded by a third communication device (third device) within the specific range. The third device may use point-to-point radio technology. The method may include the steps of: Sending a request to the second device over a setup radio communication network IP connection, the request including a request for a point-to-point connection identity associated with the second device. Obtaining, from the second device, a point-to-point connection identity associated with the second device over the radio communication network IP connection. Sending a query to the third device, requesting if it is associated with the obtained point-to-point connection identity obtained from the second device, by using said point-to-point radio technology. Receiving a message comprising information that the second device is retrieved and information how to retrieve the second device, which third device retrieved the second device using the point-to-point connection identity. Changing the setup IP connection to the second device from the radio communication network connection to a point-to-point IP connection, using the received information how to retrieve the second device.

In accordance with a second aspect of the present invention, an arrangement in a first communications device (first device) is provided. The first device is adapted to communicate with a second device over a radio communication network Internet protocol (IP) connection. The radio communication network may include a radio communication network using radio base stations, the first device and the second device may be adapted to use a point-to-point radio technology and may be adapted to communicate over a point-to-point IP connection. The point-to-point radio technology may allow for radio communication within a specific range. The first device may be adapted to be surrounded by a third communication device (third device) within the specific range. The third device may use point-to-point radio technology. The first device arrangement may include a sending unit adapted to send a request to the second device over a setup radio communication network IP connection, the request including a request for a point-to-point connection identity associated with the second device. The first device arrangement may include a receiving unit adapted to obtain from the second device, a point-to-point connection identity associated with the second device, over the radio communication network IP connection. The sending unit may be adapted to send a query to a third device requesting if it is associated with the obtained point-to-point connection identity obtained from the second device, by using said point-to-point radio technology. The receiving unit may be adapted to receive a message including information that the second device is retrieved and information how to retrieve the second device, which third device retrieved the second device using the point-to-point connection identity. The first device arrangement may include a control unit adapted to change the setup IP connection to the second device from the radio communication network connection to a point-to-point IP connection using the received information how to retrieve the second device.

Since the first device uses a setup radio communication network IP connection for obtaining a point-to-point identity associated to second device, the second device can be found and a point-to-point IP connection can be switched to for sending data. This implies that the cheaper and/or faster point-to-point IP connection can be used for data transfer.

An advantage of the present invention is that, compared to existing techniques to search a mesh network for an intended recipient this adds the advantage of already knowing whom to contact, with the purpose of continuing on the existing session but using another type of connection.

### BRIEF DESCRIPTION OF THE DRAWINGS

FIG. 1 is a schematic block diagram illustrating an exemplary network wherein a first device may communicate with a second device;

FIG. 2 is a combined signaling scheme and flowchart illustrating an embodiment in which a method described herein may be implemented;

FIG. 3 is a schematic block diagram illustrating an exemplary network wherein a first device may communicate with a second device;

FIG. 4 is a combined signaling scheme and flowchart illustrating another embodiment in which a method described herein may be implemented;

FIG. 5 is a flowchart illustrating an exemplary method which may be implemented in a communication device;

FIG. 6 is a functional block diagram illustrating exemplary components in a communication device;

FIG. 7 is a schematic block diagram illustrating a mobile phone including exemplary functional components; and

FIG. 8 is a schematic block diagram illustrating an exemplary storage medium having computer program code thereon for executing systems and methods which may be implemented as described herein.

### DETAILED DESCRIPTION OF THE INVENTION

FIG. 1 shows an exemplary first communication device 100 (hereinafter, first device 100) communicating with a second communication device 110 (hereinafter, second device 110) via a radio communication network Internet protocol (IP) connection 120 (shown as dashed lines) over a radio communication network. The radio communication network may include a cellular type of radio communication network that uses radio base stations 125 and uses radio technology, such as Global System for Mobile (GSM) communication, General Packet Radio Service (GPRS), Wideband Code Division Multiple Access (WCDMA), or other radio protocol. Radio base stations 125 may communicate with each other using intermediate nodes in any conventional way that need not be recited in detail herein. First communication device 100 and second communication device 110 may include, for example, a portable device, a mobile phone, a Personal Digital Computer (PDA), or any other radio communication device or mobile terminal.

To obtain higher speeds and/or lower costs when communicating (e.g., transferring data), first communication device 100 and second communication device 110 may use a point-to-point radio technology, such as Wireless Fidelity (WiFi), Bluetooth®, a meshed network technology, or other protocol. Point-to-point radio technology generally refers to a radio technology for communication between two points, i.e., between two endpoints (e.g., communication devices), for example, without interposing radio base stations.

WiFi includes the underlying technology of wireless local area networks (WLAN) based on the IEEE 802.11 specifications. WiFi was developed to be used for mobile computing devices, such as laptops, in LANs, but is now increasingly used for more services, including Internet and VoIP phone access, gaming, and basic connectivity of consumer electronics such as televisions and DVD players, or digital cameras.

Bluetooth includes a wireless Personal Area Network (PAN). Bluetooth provides a way to connect and exchange information between devices such as mobile phones, laptops, PCs, printers, digital cameras, and video game consoles over a secure, globally unlicensed short-range radio frequency.

A mesh network includes a Local Area Network (LAN) that employs one or two connection arrangements, full mesh topology or partial mesh topology. In the full mesh topology, each node (workstation or other device) connects directly to each of the others in point-to-point connections. In the partial meshed topology, some nodes connect in point-to-point connections to all the others, but some of the nodes connect only to those other nodes with which they exchange the most data.

Point-to-point radio technology may allow for first communication device 100 and second communication device 110 to communicate via a point-to-point IP connection. Point-to-point radio technology may allow for radio communication within a specific range, i.e., communication between “vicinity devices” within the specific range. As used herein, a vicinity device may generally denote a device being within the specific point-to-point radio range from another device, which may vary from a distance of several meters up to a couple of kilometres, depending on which point-to-point radio technology that is used (e.g., Bluetooth™ in the range of 100 meters or less, and WiFi, in the range of several hundred meters, etc.).

As shown in FIG. 1, first communication device 100 may be among a number of third devices 130 within the operative range, which third devices 130 may use point-to-point technology. First communication device 100 may be adapted to communicate directly with one or more of third devices 130 using point-to-point technology. I.e., third devices 130 may be in the vicinity of first communication device 100. The possible point-to-point communication ranges are shown as (solid) lines between the different various devices.

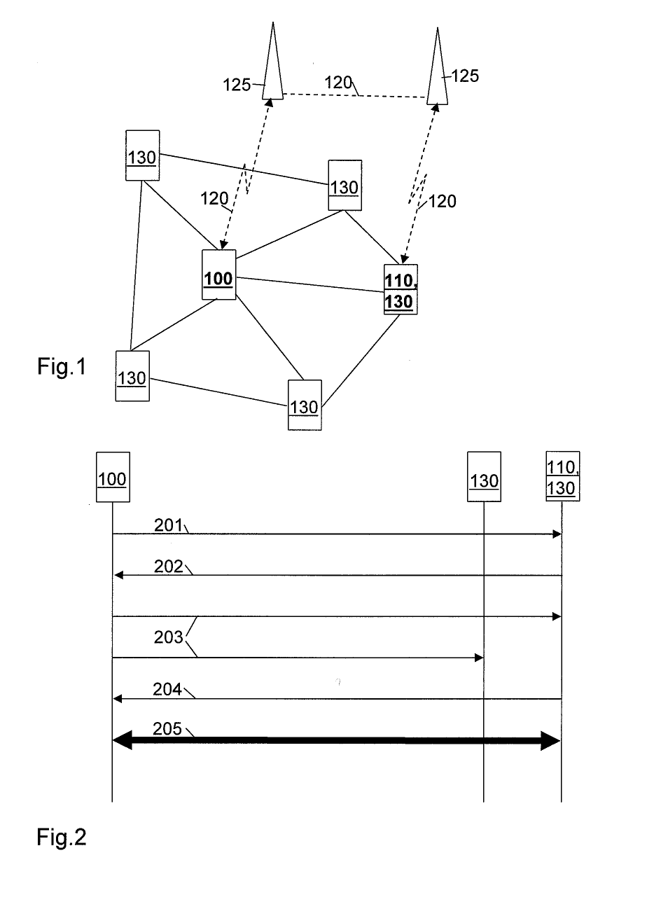

FIG. 2 is a schematic signaling scheme describing an exemplary method for establishing a point-to-point IP connection between first communication device 100 and second communication device 110. First communication device 100 may communicate with second communication device 110 on established radio communication network IP connection 120. First communication device 100 may desire to send data, such as a picture, a music file, text file or any other form of data transmission, to second communication device 110. To accomplish the data transfer, first communication device 100 may opt to use point-to-point radio technology for the transfer (e.g., to reduce, transmission time, etc.).

First communication device 100, being among a number of different third devices 130 using point-to-point technology, in FIG. 1, may have yet to determine whether any of third devices 130 includes second communication device 110. If any of the third devices 130 includes second communication device 110, first communication device 100 may have yet to identify which of third devices 130 includes second communication device 110. First communication device 100 may first retrieve second communication device 110 to be able to perform the intended transfer of data over a point-to-point IP connection to second communication device 110. In FIG. 2, assume that second communication device 110 is one of third devices 130 within the specific range. That is, second communication device 110 is a vicinity device relative to first communication device 100. A method according to one implementation may include the following acts depicted in FIG. 2:
201. To retrieve second communication device 110 from among third devices 130, first communication device 100 may use a point-to-point connection identity associated with second communication device 110. The point-to-point connection identity could either include some existing identity in the technology used, such as a media access control (MAC) address, or be created dynamically within a system for identification purposes. First communication device 100 may send a message to second communication device 110 over established radio communication network IP connection 120, which may include a request for the point-to-point connection identity of second communication device 110.
202. Second communication device 110 may obtain the requested point-to-point connection identity, for example, by generating a point-to-point connection identity. Second communication device 110 may send the generated point-to-point connection identity associated with second communication device 110 to first communication device 100, for example, over established radio communication network IP connection 120. First communication device 100 may receive, from second communication device 110, the point-to-point connection identity associated with second communication device 110.
203. First communication device 100 may query vicinity devices regarding the obtained point-to-point connection identity associated with second device 110, i.e., first communication device 100 may query third devices 130 for any device having the obtained point-to-point connection identity, for example, using point-to-point technology.
204. In FIG. 2, second communication device 110 is one of third devices 130, i.e., second communication device 110 is in the vicinity of first communication device 100. Second communication device 110 may receive the query transmitted from first communication device 100 and indicate that it is associated with the queried point-to-point connection identity. Second communication device 110 may inform first communication device 100, for example, using the point-to-point technology. Using the point-to-point technology, first communication device 100 may obtain the information that second communication device 110 is identified as being associated with the queried point-to-point connection identity.
205. First communication device 100 may have thus retrieved second communication device 110, and change from radio communication network IP connection 120 to a point-to-point IP connection to second communication device 110. The IP connection between first communication device 100 and second communication device 110 may be recreated over the point-to-point IP connection, including necessary identification and session data, before the previous radio base station-based communications channel is abandoned. First communication device 100 may initiate data transfer to second communication device 110 over the point-to-point connection.

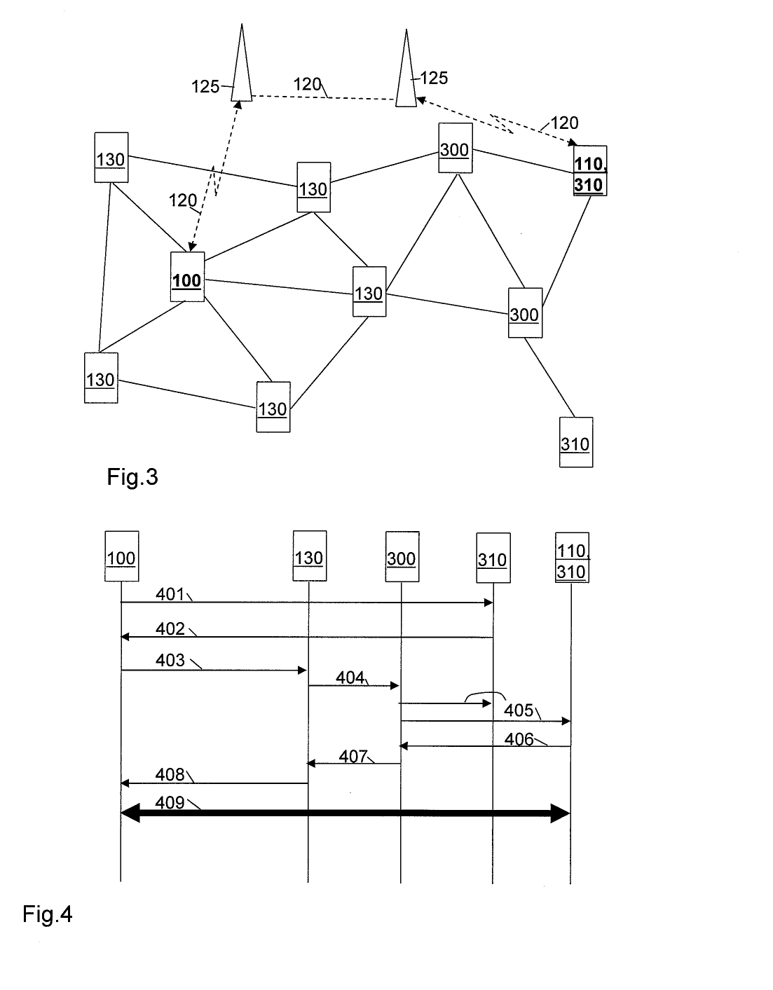

FIG. 3 is a schematic block diagram of an exemplary network configuration in which second communication device 110 is not any of third devices 130. First communication device 100 may communicate with second communication device 110 via an established radio communication network IP connection 120. First communication device 100 may desire to send data, such as a picture, a music file, text file, or any other data format, to second communication device 110. To accomplish the data transfer, first communication device 100 may opt to use point-to-point radio technology for the transfer (e.g., to reduce, transmission time, etc.). First communication device 100, being among a number of different third devices 130 using point-to-point technology, may have yet to determine whether any of third devices 130 is second communication device 110.

In FIG. 3, first communication device 100 is further among a number of fourth devices 300 and fifth devices 310 outside the specific range, i.e., not in the vicinity of first communication device 100. Fourth devices 300 and fifth devices 310 may be configured to use point-to-point radio technology. Since fourth devices 300 and fifth devices 310 may be outside the specific range of first communication device 100, first communication device 100 may not be able to communicate directly with fourth devices 300 and fifth devices 310, for example, using point-to-point communication. If none of third devices 130 includes second communication device 110, first communication device 100 may attempt to retrieve second communication device 110 outside the specific range, i.e., second communication device 110 may be among one of fourth devices 300 or fifth devices 310.

Each of third devices 130 may communicate with devices within its specific range by using the point-to-point radio technology and each of fourth devices 300 may communicate with devices within its specific range by using the point-to-point technology. The possible point-to-point communication ranges between the different devices in FIG. 3 are shown as solid lines. Assume that second communication device 110 is one of fifth devices 310. First communication device 100 may yet to have determined whether any one of third devices 130, fourth devices 300, or fifth devices 310 includes second communication device 110. First communication device 100 may first retrieve second communication device 110 to be able to perform the intended data transfer via a point-to-point IP connection to second communication device 110. FIG. 3 depicts second communication device 110 as one of the fifth devices 310, i.e., outside the specific range of first communication device 100.

FIG. 4 is a combined signaling scheme describing exemplary embodiments of the present method for establishing a point-to-point IP connection to second communication device 110 in the exemplary network shown in FIG. 3. First communication device 100 may communicate with second communication device 110 via established radio communication network IP connection 120. First communication device 100 may desire to send data, such as a picture, a music file, text file or any other data format to second communication device 110. To accomplish the data transfer, first communication device 100 may opt to use point-to-point radio technology for the transfer (e.g., to reduce, transmission time, etc.). A method according to one implementation may include the following acts depicted in FIG. 4:
401. To retrieve second communication device 110 among third devices 130, fourth devices 300, and fifth devices 310, first communication device 100 may use a point-to-point connection identity associated with second communication device 110. First communication device 100 may send a message to second communication device 110 via established radio communication network IP connection 120, for example, that includes a request for the point-to-point connection identity of second communication device 110.
402. Second communication device 110 may obtain the requested point-to-point connection identity, for example, by creating a point-to-point connection identity. Second communication device 110 may send the created point-to-point connection identity associated with second communication device 110 to first communication device 100, via established radio communication network IP connection 120. First communication device 100 may receive the point-to-point connection identity from second communication device 110.
403. First communication device 100 may query vicinity devices regarding the obtained point-to-point connection identity associated with second device 110, i.e., first communication device 100 may query third devices 130 for any device having the obtained point-to-point connection identity, for example, using point-to-point technology.
404. Third devices 130 may receive the query from first communication device 100 and indicate that none are associated with the queried point-to-point connection identity. When one of third devices 130 indicates that it is not associated with the queried point-to-point connection identity, the one third device 130 may forward the query to devices in the vicinity of the one third device 130, for any device having the obtained point-to-point connection identity associated with second communication device 110, for example, using point-to-point technology. In FIGS. 3 and 4, for example, third devices 130 may query their respective vicinity devices which include, among others, fourth devices 300.
405. Assume, in FIGS. 3 and 4, ones of fourth devices 300 are vicinity devices relative to a respective third device 130, and thus receive the query. When one of fourth devices 300 indicates that it is not associated with the queried point-to-point connection identity, the one fourth device 300 may forward the query to devices in the vicinity of the one fourth device 300, for any device having the obtained point-to-point connection identity associated with second communication device 110, for example, using point-to-point technology. That is, in FIGS. 3 and 4, each of fourth devices 300 may query their respective vicinity devices which may include, among others, fifth devices 310. The forwarding procedure may continue until, for example, second communication device 110 is identified, all vicinity devices have indicated that they already have been queried, or upon expiration of a predetermined time limit.
406. In FIGS. 3 and 4, second communication device 110 may be one of fifth devices 310. Second communication device 110, 310 may receive the query from one of fourth devices 300, and indicate that it is associated with the queried point-to-point connection identity. Second communication device 110, 310 may determine the path traversed the query, i.e., the devices through which the query is forwarded on the way to second communication device 110. Second communication device 110 may informs first communication device 100 in response, for example, by sending the information in a message, using point-to-point radio technology via the devices in a reverse order of the determined path. For example, the information may be sent to the one fourth device 300 from which the query was received. The message may include information indicating that second communication device 110 has been retrieved, and information about the determined path to be used for locating second communication device 110. If any identity associated with first communication device 100 were included in the query, this may be used for determining a return path to first communication device 100.
407. The one fourth device 300 that may obtain the message including information identifying second communication device 110 and the determined path, may forward the information to third device 130 using, for example, point-to-point radio technology, for example, via the determined path corresponding to a reverse traversal.
408. The one third device 130 that obtains the message including the information identifying second communication device 110 and the determined pathway, may forward the information to first communication device 130, for example, using point-to-point radio technology, and via the determined pathway in opposite order. The forwarding procedure may continue until the information reaches first communication device 100 or until a predetermined time limit has expired.
409. First communication device 100 may receive the message including the information identifying second communication device 110 and the determined pathway, for example, via point-to-point radio technology. First communication device 100 may have thus retrieved second communication device 110. Second communication device 110 may not be a vicinity device relative to first communication device 110, but may connect thereto using point-to-point radio technology via intermediate devices, for example, over the determined route. First communication device 100 may thus change from established radio communication network IP connection 120 to second communication device 110 to an IP connection using a point-to-point IP connection between first communication device 100 and second communication device 110 over the designated route. An IP connection between first communication device 100 and second communication device 110 may thus be re-established over the point-to-point IP connection, including necessary identification and session data, before the previous radio base station based communications channel is abandoned. First communication device 110 may begin data transfer to second communication device 110 via the point-to-point connection.

In some implementations, each time the query is forwarded by a specific device, a “finger print” identifying the specific device may be added to the query so that a path can be identified between first communication device 100 and second communication device 110.

In some implementations, each device may maintain information as to whether it has already queried vicinity devices for any specific device associated with a specific point-to-point connection identity, so if a new query of the same specific device is received, the device may inform of any ongoing actions such as answer “querying ongoing,” “query performed, device found,” or “query performed, device not found.” Such information may be maintained for a predetermined limited time.

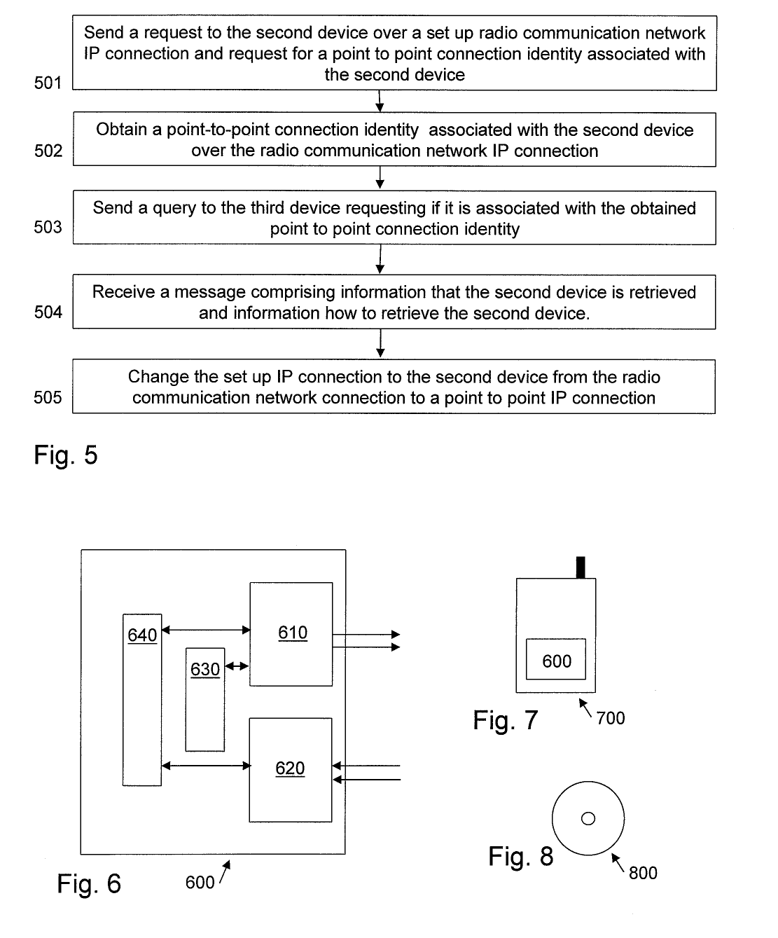

Exemplary method steps that may be implemented in first communication device 100 for setting up a point-to-point IP connection to a second device 110 will now be described with reference to a flow chart depicted in FIG. 5. As mentioned above, first communication device 100 may be adapted to communicate with second communication device 110 over a radio communication network IP connection 120. The radio communication network may include a radio communication network using radio base stations. First communication device 100 and second communication device 110 may use point-to-point radio technology and be adapted to communicate over a point-to-point IP connection. Point-to-point radio technology may allow for radio communication within a specific range. First communication device 100 may be located within the specific range relative to a third device 130. Third device 130 may use point-to-point radio technology. The exemplary method may include:
501. A source communication device may send a request to a destination communication device via an established radio communication network IP connection. The request may include a request for a point-to-point connection identity associated with the destination communication device.
502. The source communication device may obtain, from the destination communication device, a point-to-point connection identity associated with destination communication device via the established radio communication network IP connection.
503. The source communication device may send a query to surrounding communication devices inquiring whether the surrounding communication devices are associated with the obtained point-to-point connection identity obtained from the destination communication device, for example, using point-to-point radio technology. In some embodiments, the source communication device may be located within operating range of at least one remote radio communication device (remote device) (e.g., fourth device 300 and fifth device 310 mentioned above). The remote device may be outside the specific range of the source communication device. The remote devices may use point-to-point radio technology. In these embodiments, the query further includes a request to, if the queried device has identified that it is not associated with the point-to-point connection identity, forward the query to the remote device and request if the remote device is associated with the point-to-point connection identity obtained from the destination communication device, for example, using point-to-point radio technology. The remote device may be within the specific range of the forwarding device. In some embodiments, the query further includes a request to continue to forward the query to another remote device until the query is received by the destination communication device, which identifies that it is associated with the point-to-point connection identity. In some embodiments, the query further includes a request to a device that forwards the query, to add a fingerprint or other identifier) of the forwarding device to the query when forwarding it, so that the transmission route may be determined. In some embodiments, the query further includes a request to, if the queried device has identified that it is the destination communication device associated with the point-to-point connection identity, note the transmission route and send a message to the source communication device. The message including information that the destination communication device is retrieved, and information how to communicate to the destination communication device 110 represented by the determined route. The message to be sent from the destination communication device to the source communication device 100 via any remote device and via any intermediary device, using the determined transmission route, for example, using point-to-point radio technology. In some embodiments, the query further includes a limitation that a device that receives the same query a second time, regarding the same second device, shall not forward the query. In some embodiments, the query further includes a limitation that a device that receives the same query a second time within a predetermined time period from the first received query, regarding the same second device, shall not forward the query. In some embodiments, in which the query further includes a request to respond to the device sending the second query, about ongoing actions (e.g., state information), if a device, receives the same query for a second time.
504. The source communication device may receive a message including information that the destination communication device has been retrieved and information regarding the determined transmission route between the source communication device and the destination communication device. The intermediary device may have retrieved the destination communication device using the point-to-point connection identity. In some embodiments, the information how to retrieve the destination communication device may be represented by a route that includes information about which devices via which the query passed until the query was ultimately received by the destination communication device.
505. The source communication device may thereby change the existing IP connection to the destination communication device from the radio communication network connection to a point-to-point IP connection using the acquired information regarding retrieval of the destination communication device.

To implement one or more of the above-described steps for setting up a point-to-point IP connection to second device 110, first communication device 100 may include an apparatus arrangement 600 depicted in FIG. 6.

First device arrangement 600 may include a sending unit 610. Sending unit 610 may be adapted to send a request to second communication device 110 over a setup radio communication network IP connection 120. The request may include a request for a point-to-point connection identity associated with second communication device 110. The sending unit 610 may be adapted to send a query to third device 130, by using point-to-point radio technology. The query may inquire as to whether third device 130 is associated with the obtained point-to-point connection identity obtained from second communication device 110.

In some embodiments, first communication device 100 may be adapted to be surrounded by at least one remote radio communication device (remote device) outside the specific range of first communication device 100. The remote devices may use point-to-point radio technology. In these embodiments, the query, adapted to be sent by sending unit 610, may include a request to, if the queried device has indicated that it is not associated with the point-to-point connection identity, forward the query to the remote device and inquire as to whether the remote device is associated with the point-to-point connection identity obtained from second communication device 110. The point-to-point radio technology may be used. The remote device may be located within the specific range of the forwarding device.

In some embodiments, the query, adapted to be sent by sending unit 610, may be adapted to continue to be forwarded to another remote device until the query is received by second communication device 110, which second device 110 may indicate that it is associated with the point-to-point connection identity.

In some embodiments, the query, adapted to be sent by sending unit 610, may include a request to a device that forwards the query, to add a fingerprint of the forwarding device to the query when forwarding it, so that a path can be defined.

In some embodiments, the query, adapted to be sent by sending unit 610, may include a restriction that a device receiving the same queries a second time, regarding second communication device 110, shall not forward the query.

In some embodiments, the query, adapted to be sent by sending unit 610, may include a restriction that a device receiving the same query a second time within a predetermined time period from the first received query regarding second communication device 110, shall not forward the query.

In some embodiments the query, adapted to be sent by sending unit 610, may include a request to respond to the device, sending the second query, about ongoing actions, if a device receives the same query for the second time.

First device arrangement 600 may include a receiving unit 620. Receiving unit 620 may be adapted to obtain from second communication device 110, a point-to-point connection identity associated with second communication device 110, over the radio communication network IP connection 120. Receiving unit 620 may be adapted to receive a message. The message may include information that second communication device 110 is retrieved and information how to retrieve second communication device 110. Third device 130 may have retrieved second communication device 110 using the point-to-point connection identity.

In some embodiments, the information how to retrieve second communication device 110, adapted to be received by receiving unit 620, may be represented by a pathway. The pathway may include identify which nodes the query passed until the query was received by second communication device 110.

In some embodiments the query, adapted to be sent by sending unit 610, may include a request to, if the queried device has identified that it is second communication device 110 associated with the point-to-point connection identity, note the path and send the message, adapted to be received by receiving unit 620. The message including information that second communication device 110 is retrieved and information how to retrieve second communication device 110 represented by the noted path. The message may be adapted to be sent from second communication device 110 to first communication device 100 via any remote device and via third communication device 130, retracing the noted path, for example, using the point-to-point radio technology.

First device arrangement 600 may include a control unit 630. Control unit 630 may be adapted to change the setup IP connection to second communication device 110 from radio communication network connection 120 to a point-to-point IP connection using the received information how to retrieve second communication device 110.

FIG. 7 depicts a mobile phone 700 comprising the first device arrangement 600.

The present point-to-point IP connection setup mechanism may be implemented through one or more processors, such as processor 640 in first device arrangement 600 depicted in FIG. 6, together with computer program code for performing the functions of the invention. The above-mentioned program code may be provided as a computer program product, for instance in the form of a data carrier carrying computer program code for performing the present method when being loaded into first communication device 100. One such carrier may be in the form of a CD ROM disc 800 depicted in FIG. 8. It is, however, feasible with other data carriers such as a memory stick. The computer program code can furthermore be provided as pure program code on a server and downloaded to first communication device 100 remotely.

As used herein, the terms “comprise”/“comprising” and/or “includes”/“including” shall be interpreted as non-limiting (e.g., non-exclusive), in the meaning of “consists at least of,” or the like.

The present invention is not limited to the above-describe preferred embodiments. Various alternatives, modifications and equivalents may be used. Therefore, the above embodiments should not be taken as limiting the scope of the invention, which is defined by the appending claims.

1-20. (canceled)

21. In a first communication device, a method of establishing a point-to point Internet protocol (IP) connection to a second communication device, the method comprising:
sending a request to the second communication device via a radio communication network IP connection, the request including a request for a point-to-point connection identity associated with the second communication device;
receiving the point-to-point connection identity from the second communication device via the radio communication network IP connection;
configuring a query to forward to a third communication device using point-to-point radio technology, the query to inquire whether the point-to-point connection identity is associated with the third communication device;
receiving, from the third communication device, a message including information identifying the second communication device as being associated with the point-to-point connection identity and information regarding a determined point-to-point IP connection route to locate the second communication device;
establishing the point-to-point IP connection to the second communication device using the received information; and
ending the radio communication network IP connection to the second communication device upon the establishing the point-to-point IP connection.

22. The method of claim 21, further comprising:
configuring the query, when a determination is made that the third communication device is not associated with the point-to-point connection identity, to request further forwarding of the query by at least one other communication device to the second communication device using the point-to-point radio technology, wherein the second communication device is outside a point-to-point radio communication range of the first communication device.

23. The method of claim 22, further comprising:
configuring the query to request the at least one other communication device to further forward the query until the query is received by the second communication device.

24. The method of claim 21, wherein the information regarding the determined point-to-point IP connection route comprises identities of each of a number of communication devices that forwarded the query en route to the second communication device.

25. The method of claim 24, further comprising:
further configuring the query to request each of the number of communication devices to add to the query a fingerprint associated with respective ones of the number of communication devices.

26. The method of claim 24, wherein the determined point-to-point IP connection route differs from a path that the query traversed to the second communication device.

27. The method of claim 22, further comprising:
configuring the query to not be forwarded twice by the at least one other communication device.

28. The method of claim 22, further comprising:
further configuring the query to include a restriction, that the at least one other communication device receiving the query a second time within a predetermined time period from having previously received the query, shall not forward the query.

29. The method of claim 28, further comprising:
further configuring the query, when the at least one other communication devices receives the query twice, to include a request a state of the forwarding of the query.

30. A computer-readable storage device including instructions executable in a first communication device to establish a point-to-point IP connection to a second communication device, comprising:
instructions to send a request to the second communication device via a radio communication network IP connection, the request including a request for a point-to-point connection identity associated with the second communication device;
instructions to receive the point-to-point connection identity from the second communication device via the radio communication network IP connection;
instructions to configure a query for forwarding to a third communication device using point-to-point radio technology, the query inquiring whether the point-to-point connection identity is associated with the third communication device;
instructions to receive, from the third communication device, a message including information identifying the second communication device as being associated with the point-to-point connection identity and information regarding a determined point-to-point IP connection route to locate the second communication device;
instructions to establish the point-to-point IP connection to the second communication device using the received information; and
instructions to end the radio communication network IP connection to the second communication device upon the establishing the point-to-point IP connection.

31. An arrangement in a first communication device, the first device being configured to communicate to a second device using a radio communication network Internet Protocol (IP) connection and using point-to-point radio technology over a point-to-point IP connection, the arrangement comprising:
a sending unit to send a request to the second device for a point-to-point connection identity associated with the second communication device;
a receiving unit to receive the point-to-point connection identity from the second device, via the radio communication network IP connection,
a query unit to generate a query to forward to a third communication device using the point-to-point radio technology, the query to inquire whether the point-to-point connection identity is associated with the third device;
the receiving unit to receive, from the third communication device, a message including information identifying the second communication device as being associated with the point-to-point connection identity and information regarding a determined point-to-point IP connection route to locate the second communication device; and
a control unit to establish the point-to-point IP connection to the second communication device using the received information and end the radio communication network IP connection to the second communication device upon the establishing the point-to-point IP connection.

32. The arrangement of claim 31, the query unit to configure the query, when a determination is made that the third communication device is not associated with the point-to-point connection identity, to request further forwarding of the query by at least one other communication device to the second communication device using the point-to-point radio technology, wherein the second communication device is outside a point-to-point radio communication range of the first communication device.

33. The arrangement of claim 32, the query unit to configure the query to request the at least one other communication device to further forward the query until the query is received by the second communication device.

34. The arrangement of claim 31, wherein the information regarding the determined point-to-point IP connection route comprises identities of each of a number of communication devices that forwarded the query en route to the second communication device.

35. The arrangement of claim 34, the query unit to configure the query to request each of the number of communication devices to add to the query a fingerprint associated with respective ones of the number of communication devices.

36. The arrangement of claim 34, wherein the determined point-to-point IP connection route differs from a path that the query traversed to the second communication device.

37. The arrangement of claim 32, the query unit to configure the query to not be forwarded twice by the at least one other communication device.

38. The arrangement of claim 32, the query unit to configure the query to include a restriction, that the at least one other communication device receiving the query a second time within a predetermined time period from having previously received the query, shall not forward the query.

39. The arrangement of claim 38, the query unit to configure the query, when the at least one other communication devices receives the query twice, to include a request a state of the forwarding of the query.

40. The arrangement of claim 31, wherein arrangement resides in a mobile phone.
